(19) United States
(12) Patent Application Publication
(10) Pub. No.: US 2008/0170055 A1
(43) Pub. Date: Jul. 17, 2008

(54) APPARATUS FOR RECEIVING A SIGNAL AND DISPLAY APPARATUS HAVING THE SAME

(76) Inventors: Jong-Tae Kim, Asan-si (KR); Seoung-Bum Pyoun, Osan-si (KR)

Correspondence Address: F. CHAU & ASSOCIATES, LLC, 130 WOODBURY ROAD, WOODBURY, NY, 11797, US

(21) Appl. No.: 11/968,707

(22) Filed: Jan. 3, 2008

(30) Foreign Application Priority Data
Jan. 11, 2007 (KR) 2007-3103

(51) Int. Cl. G06F 3/038

(52) U.S. Cl. 345/205

(57) ABSTRACT

A connector receives first and second differential signals. First and second signal lines are connected to the connector, and transmit the first and second differential signals, respectively. First and second differential capacitors have first and second end terminals to remove noise components of the first and second differential signals. Each of the first end terminals is connected to ground potential. The second end terminals are connected to the first and second differential lines, respectively. A differential resistor is connected to the first and second signal lines to remove the noise components of the first and second differential signals. A receiving part is connected to the first and second signal lines to receive the first and second differential signals through the differential resistor and the first and second differential capacitors.

### CROSS-REFERENCE TO RELATED APPLICATION

This application claims priority under 35 U.S.C. § 119 to Korean Patent Application No. 2007-3103, filed on Jan. 11, 2007, the contents of which are herein incorporated by reference in their entirety.

### BACKGROUND OF THE INVENTION

1. Technical Field

The present invention relates to an apparatus for receiving a signal and a display apparatus having the apparatus, more particularly, to an apparatus for receiving a signal capable of receiving a stable signal.

2. Discussion of the Related Art

A liquid crystal display (LCD) apparatus displays images using optical and electrical properties of liquid crystal layer. The LCD apparatus includes a display panel for displaying images and a driving circuit part for driving the display panel. The display panel includes a plurality of pixel parts. A printed circuit board (PCB) having control circuit can be used to provide control signals to the driving circuit part. The driving circuit part includes a gate driving part for outputting a gate signal to the gate lines, a data driving part for outputting a data voltage to the data lines, and a timing control section for receiving image data and synchronizing signals to drive the gate and data driving parts.

Noise may be generated due to high speed and high capacity data transmissions, and errors may be increase due to interference between signal lines. A differential signaling transmission method can reduce the noise and errors by transmitting differential signals through a pair of signal lines facing each other.

Differential signaling transmission can be used when control signals are provided from a PCB. However, if the signal lines have impedance that are different, signal reflection may distort the signal transmissions.

### SUMMARY OF THE INVENTION

Embodiments of the present invention provide an apparatus for receiving a signal preventing distortion of a driving signal provided from an external device to receive a stable driving signal, and a display apparatus having the apparatus.

In an exemplary embodiment of the present invention, an apparatus for receiving a signal includes a connector, first and second signal lines, first and second differential capacitors, a differential resistor and a receiving part. The connector receives a first differential signal and a second differential signal having substantially the same amplitude and substantially opposite phase to the first differential signal from an external device. The first and second signal lines are electrically connected to the connector. The first and second signal lines transmit the first and second differential signals, respectively. The first and second differential capacitors have a first end terminal and a second end terminal to remove noise components of the first and second differential signals, respectively. Each of the first end terminals is electrically connected to a ground potential. The second end terminals are electrically connected to the first and second differential lines, respectively. The differential resistor is electrically connected to the first and second signal lines to remove the noise components of the first and second differential signals. The receiving part is electrically connected to the first and second signal lines to receive the first and second differential signals through the differential resistor and the first and second differential capacitors. Noise components may be removed from the first and second differential signals.

In an exemplary embodiment of the present invention, a display apparatus includes a display panel, a connector, a timing control section, first and second differential lines, a differential resistor, and first and second differential lines. The display panel has a plurality of pixel parts. The connector receives a driving signal including a first differential signal and a second differential signal from an external device. The timing control section receives the driving signal to control the pixel parts. The first and second differential lines respectively transmit the first and second differential signals to the timing control section. The differential resistor is formed between the first and second differential lines. Each of the first and second differential capacitors includes a first end terminal electrically connected to a ground potential and a second end terminal electrically connected to each of the first and second differential lines.

In an exemplary embodiment of the present invention, a display apparatus includes a display panel, a connector, a timing control section, a plurality of signal lines and a noise suppression part. The display panel has a plurality of pixel parts. The connector receives a driving signal including a first differential signal and a second differential signal from an external device. The timing control section receives the driving signal to control the pixel parts. The signal lines transmit a driving signal provided through the connector to the timing control section. The noise suppression part is electrically connected to the signal lines to suppress a noise component of the driving signal.

According to the apparatus for receiving a signal and the display apparatus having the apparatus for receiving a signal, the differential resistor, and the first and second capacitors are formed in signal lines formed between the connector and the timing control section of the printed circuit board (PCB) to transmit differential signals, so that distortion of the driving signal may be decreased. Furthermore, a stable driving signal may be transmitted to the timing control section.

### BRIEF DESCRIPTION OF THE DRAWINGS

Exemplary embodiments of the present invention can be understood in more detail from the following descriptions taken in conjunction with the accompanying drawings, in which:

FIG. 1 is a perspective view of a display apparatus according to an exemplary embodiment of the present invention;

FIG. 2 is a plan view of the display apparatus of FIG. 1; and

FIG. 3 is an equivalent circuit diagram schematically illustrating signal lines between the connector and the timing control section of FIG. 1.

### DESCRIPTION OF EXEMPLARY EMBODIMENTS

Embodiments of the invention are described more fully hereinafter with reference to the accompanying drawings. This invention may, however, be embodied in many different forms and should not be construed as limited to the embodiments set forth herein. It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

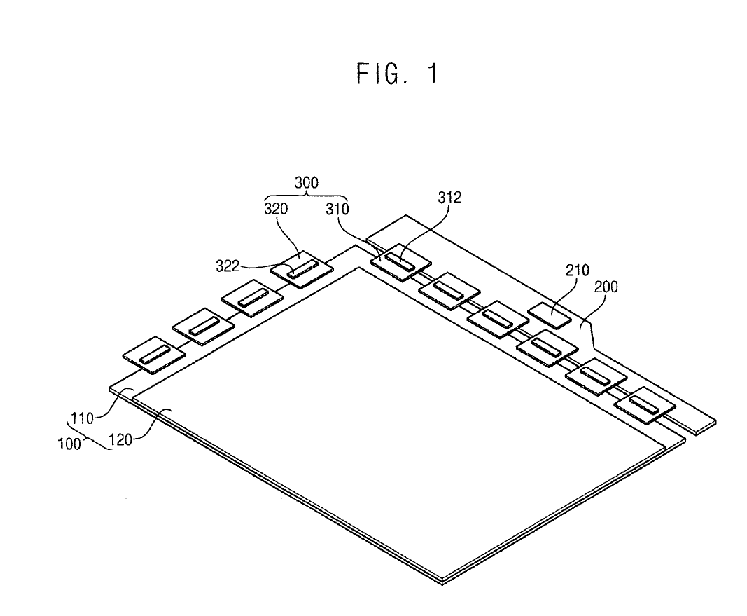

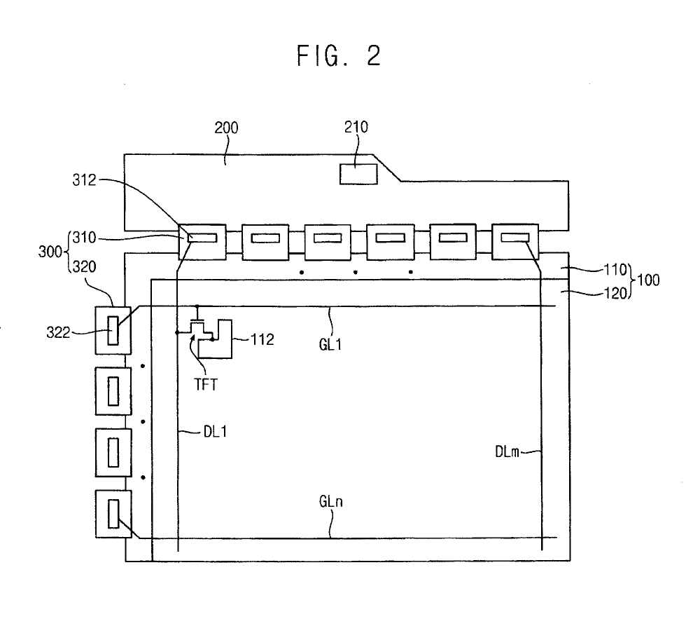

FIG. 1 is a perspective view of a display apparatus according to an exemplary embodiment of the present invention. FIG. 2 is a plan view of the display apparatus of FIG. 1.

Referring to FIGS. 1 and 2, a display apparatus according to an exemplary embodiment of the present invention includes a display panel 100 displaying an image, a printed circuit board (PCB) 200 and a plurality of driving circuit films 300.

The display panel 100 includes an array substrate 110, an opposite substrate 120 such as, for example, a color filter substrate facing the array substrate 110, and a liquid crystal layer (not shown) interposed between the array substrate 110 and the opposite substrate 120.

The array substrate 110 includes a plurality of gate lines GL1 through GLn, and a plurality of data lines DL1 through DLm. The gate lines GL1 through GLn are extended along a first direction, and the data lines DL1 through DLm are extended along a second direction crossing the first direction, wherein ‘n’ and ‘m’ represent natural numbers. In an exemplary embodiment, the gate lines GL1 through GLn and the data lines DL1 through DLm define a plurality of pixel parts, however the pixel parts may also be otherwise defined. Each of the pixel parts includes a thin-film transistor (TFT) electrically connected to the gate line GL and the data line DL, and a pixel electrode 112 electrically connected to the TFT. The pixel electrode 112 acts as a first electrode of a liquid crystal capacitor CLC. The TFT includes a gate electrode electrically connected to the gate line GL, a source electrode electrically connected to the data line DL, and a drain electrode electrically connected to the pixel electrode 112. Each of the pixel parts may further include a storage capacitor CST electrically connected to the TFT.

The opposite substrate 120 includes a plurality of color filters (not shown) such as, for example, a red color filter, green color filter and blue color filter to display colors. The color filters correspond to each of the pixel parts. The opposite substrate 120 may include, for example, transparent glass. The opposite substrate 120 may further include a common electrode (not shown) including an optionally transparent and electrically conductive material. The pixel electrode 112, the common electrode and an organic substance interposed between the pixel and common electrodes may form a liquid crystal capacitor (not shown).

When a high level of a gate voltage is applied to the gate electrode of the TFT, the TFT is turned on. Then, a data voltage is applied to the pixel electrode through the TFT. When the data voltage is applied to the pixel electrode 112, electric fields are generated between the pixel electrode 112 and the common electrode to alter an arrangement of liquid crystal molecules of the liquid crystal layer disposed between the array substrate 110 and the opposite substrate 120. When the arrangement of liquid crystal molecules of the liquid crystal layer is altered, optical transmissivity of the liquid crystal layer is changed, so that images can be displayed.

The driving circuit films 300 include a plurality of data driving circuit films 310 and a plurality of gate driving circuit films 320.

Each of the data driving circuit films 310 has a first end terminal and a second end terminal. The first end terminal is attached to the display panel 100, and the second end terminal is attached to the PCB 200 to electrically connect to the display panel 100 and the PCB 200. The data driving circuit films 310 are attached to an end portion area of the data lines DL1 through DLm.

A data driving part is mounted on the data driving circuit films 310. The data driving part may include a driving chip. The data driving part may include a plurality of data driving chips 312 for dividing the data lines DL1 through DLm into a plurality of groups, and the data driving chips 312 are mounted on the data driving circuit films 310 in one-to-one correspondence.

Each of the data driving chips 312 receives a data control signal and image data from a timing control section 210 mounted on the PCB 200 and a driving voltage from the power supply (not shown). The data driving chip 312 provides the data lines DL1 through DLm with a data voltage corresponding to the image data. In an exemplary embodiment, the data control signal provided to the data driving chip 312 may include, for example, a horizontal start signal STH, a data clock signal DCLK and a load signal TP. The driving voltage provided from the power supply may include, for example, a gamma reference voltage VREF.

Each of the gate driving circuit films 320 is attached to the display panel 100 through a first end portion of the gate driving circuit film 320. For example, each of the first end portions of the gate driving circuit films 320 may be attached to an end portion area of the gate lines GL1 through GLm. The gate driving part having a driving chip is mounted on the gate driving circuit films 320. The gate driving part includes a plurality of gate driving chips 322 to drive the gate lines GL1 through GLn. Each of the gate driving chips 322 is mounted on each of the gate driving circuit films 320 in one-to-one correspondence, respectively.

Each of the gate driving chips 322 receives a gate control signal and a driving voltage provided from the timing control section 210 and the power supplying part (not shown) that are mounted on the PCB 200. The gate driving chip 322 outputs a gate signal to the gate lines GL1 through GLn. In an exemplary embodiment, the gate control signal provided from the timing control section 210 may include, for example, a vertical start signal STV and a gate clock signal GATE CLK. The driving voltage may include, for example, a gate-on voltage Von and a gate-off voltage Voff.

In an exemplary embodiment, the gate driving circuit films 320 may be omitted, the gate driving chips 322 may be directly mounted on the array substrate 110, or the gate driving part may be integrated on the array substrate 110.

The PCB 200 is attached to a second end portion of the data driving circuit films 310, so that the PCB 200 is electrically connected to the display panel 100 through the data driving circuit films 310.

In an exemplary embodiment, a connector 220, the timing control section 210 and a power supply (not shown) may be mounted on the PCB 200. The power supply may be integrated into the timing control section 210.

The connector 220 receives a driving signal for driving the display panel 100 from an external device (not shown). The connector 220 provides the timing control section 210 with the driving signal. The driving signal may include, for example, image data, a vertical synchronizing signal (VSYNC), a horizontal synchronizing signal (HSYNC), a main clock signal (MCLK), and a data enable signal (DE). The vertical synchronizing signal (VSYNC) represents a time required for displaying one frame. The horizontal synchronizing signal (HSYNC) represents a time required for displaying one line of the frame. Thus, the horizontal synchronizing signal may include, for example, pulses corresponding to the number of pixels included in one line. The data enable signal (DE) represents a time required for supplying the pixel with data.

The timing control section 210 controls the gate driving section and the data driving section to drive the display panel 100 in response to image data and synchronizing signals which are provided from an external device through the connector 220. The timing control section 210 generates a gate control signal and a data control signal based on the synchronizing signals, and provides the gate driving section (e.g., the gate driving chip) and the data driving section (e.g., the data driving chip) with the gate control signal and the data control signal. The timing control section 210 processes the image data to be adjusted to the display panel 100, and provides the data driving section with the processed image data and the data control signal.

The power supplying section (not shown) generates and outputs a plurality of driving voltages which are required to drive the display panel 100.

A plurality of signal lines are formed in the PCB 200, which transmit the driving signals provided to the connector 220 to the timing control section 210. In a preferred embodiment of the present invention, the driving signals are transmitted differentially to the timing control section 210. For example, when a signal for transmission is converted into a first differential signal and a second differential signal to be transmitted through a pair of signal lines, a receiving side may recognize the transmitted signal as having a high value or a low value in accordance with a voltage difference between the first and second differential signals. The amplitude of the first differential signal is substantially equal to that of the second differential signal, and a phase of the first differential signal is substantially opposite to that of the second differential signal.

Differential signaling may include, for example, a low voltage differential signaling (LVDS) or a reduced swing differential signaling (RSDS), LVDS may be used in the timing control section 210.

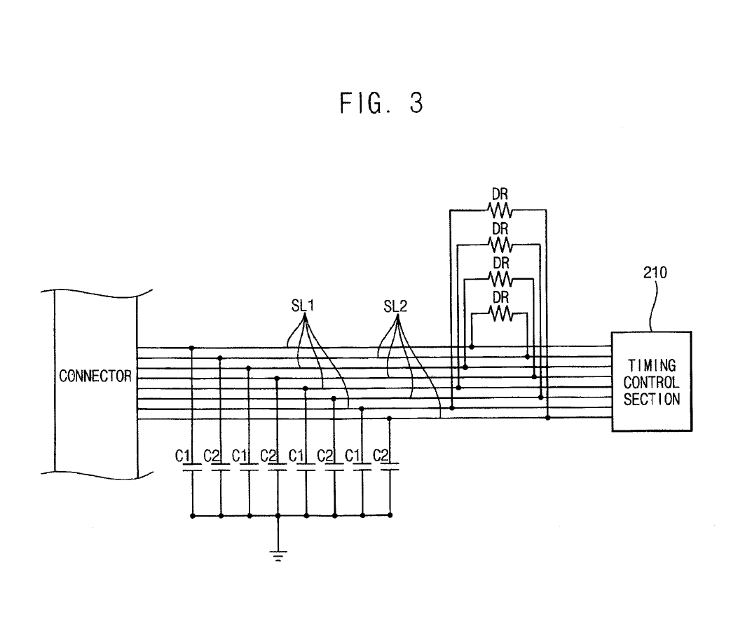

FIG. 3 is an equivalent circuit diagram schematically illustrating signal lines between the connector and the timing control section of FIG. 1.

Referring to FIGS. 1 to 3, a first differential line SL1 and a second differential line SL2 are formed between the connector 220 and the timing control section 210 that are mounted on the PCB 200. The first and second differential lines SL1 and SL2 transmit driving signals to the timing control section 210. The first differential line SL1 may be arranged in parallel with the second differential line SL2. In an exemplary embodiment, four pairs of first and second differential lines SL1 and SL2 may be formed on the PCB 200 to electrically connect the connector 220 and the timing control section 210.

A differential resistor DR is arranged between the differential line SL1 and the second differential line SL2. A first differential capacitor C1 and a second differential capacitor C2 are connected to the first differential line SL1 and the second differential line SL2, respectively. The differential resistor DR and the first and second differential capacitors C1 and C2 are referred as a noise suppression part. The noise suppression part suppresses noise components of the signals flowing through the first and second differential lines SL1 and SL2.

A first end terminal of the differential resistor DR is electrically connected to the first differential line SL1, and a second end terminal of the differential resistor DR is electrically connected to the second differential line SL2, so that the differential resistor DR is formed between the first and second differential lines SL1 and SL2. A first end terminal of the first differential capacitor C1 is grounded and a second end terminal of the first differential capacitor C2 is electrically connected to the first differential line SL1, and a first end terminal of the second differential capacitor C2 is grounded, and a second end terminal of the second differential capacitor C2 is electrically connected to the second differential line SL2. The capacitance of the first and second differential capacitors C1 and C2 may be calculated to match a reflection attenuation of a transmission medium by impedance matching.

The driving signal transmitted to the timing control section 210 may include, for example, a data signal DATA and/or a clock signal CLK (e.g., a main clock signal). The data signal DATA may include, for example, formatted image data (RGB), a vertical synchronizing signal (VSYNC), a horizontal synchronizing signal (HSYNC), and a data enable signal (DE) in correspondence to an LVDS transmission method. The clock signal CLK may include, for example, a main clock signal MCLK which is formatted in correspondence with the LVDS transmission method. In an exemplary embodiment, the data signal DATA may include, for example, three pairs of the first and second differential signals to be transmitted to the timing control section 210 through the three pairs of the first and second differential lines SL1 and SL2 formed between the connector 220 and the timing control section 210. The clock signal CLK may include, for example, a pair of the first and second differential signals to be transmitted to the timing control section 210 through the pair of the first and second differential lines SL1 and SL2.

The differential resistor DR and the first and second connectors C1 and C2 are formed in the first and second differential lines SL1 and SL2 formed between the connector 220 and the timing control section 210 of the display device according to an exemplary embodiment of the present invention. The differential resistor DR and the first and second capacitors C1 and C2 may remove ripple components, such as high frequency noise, that are generated in the first and second differential signals.

The differential resistor DR and the first and second capacitors C1 and C2 match impedance between the connector and the timing control section, so that a reflection wave induced between end portions of the signal line and an effect of a mismatching coupling may be decreased.

Furthermore, the first and second differential capacitors C1 and C2 are operated as a data filter, so that distortion of a driving signal may be decreased. As a result, the driving signal provided from an external device through the connector may be reliably transmitted to the timing control section 210.

According to exemplary embodiments of the present invention, the differential resistor, and the first and second capacitors are formed in the first and second differential lines for transmitting a driving signal to the timing control section in accordance with a differential signaling transmission method, so that distortion of the driving signal may be decreased.

Although the exemplary embodiments of the present invention have been described herein with reference with the accompanying drawings, it is understood that the present invention is not be limited to these exemplary embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. An apparatus for receiving a signal, the apparatus comprising:
a connector receiving a first differential signal and a second differential signal, the second differential signal having substantially the same amplitude and substantially opposite phase to the first differential signal;
first and second signal lines connected to the connector, the first and second signal lines transmitting the first and second differential signals, respectively;
first and second differential capacitors each having a first end terminal and a second end terminal, the first end terminals of the first and second differential capacitors connected to a ground potential and the second end terminals of the first and second differential capacitors connected to the first and second differential lines, respectively;
a differential resistor connected to the first and second signal lines; and
a receiving part connected to the first and second signal lines to receive the first and second differential signals through the differential resistor and the first and second differential capacitors.

2. A display apparatus comprising:
a display panel having a plurality of pixel parts;
a connector receiving a driving signal including a first differential signal and a second differential signal;
a timing control section receiving the driving signal to control the pixel parts;
first and second differential lines transmitting the first and second differential signals to the timing control section;
a differential resistor formed between the first and second differential lines; and
first and second differential capacitors, each of the first and second differential capacitors including a first end terminal connected to a ground potential and a second end terminal connected to each of the first and second differential lines.

3. The display apparatus of claim 2, wherein a capacitance of the first and second differential capacitors is a value corresponding to an impedance matching.

4. The display apparatus of claim 2, further comprising:
a plurality of driving circuit films having a first end portion attached to the display panel; and
a printed circuit board (PCB) attached to a second end portion of the driving circuit films, the PCB having the connector and the timing control section mounted on the PCB.

5. The display apparatus of claim 4, wherein the driving circuit films comprise at least one gate driving circuit film,
wherein at least one gate driving chip is mounted on the gate driving circuit film to apply a gate signal to the gate lines in response to a control of the timing control section.

6. The display apparatus of claim 4, wherein the driving circuit films comprise at least one data driving circuit film,
wherein at least one data driving chip is mounted on the data driving circuit film to apply a data signal to the data lines in response to a control signal from the timing control section.

7. The display apparatus of claim 3, wherein the driving signal comprises a data signal and a clock signal,
wherein the data signal is formatted to a first data differential signal and a second data differential signal formed by one of formatting image data, a vertical synchronizing signal (VSYNC), a horizontal synchronizing signal (HSYNC), or a data enable signal (DE) in correspondence with a low voltage differential signaling (LVDS) transmission method, and the clock signal is formed by formatting a main clock signal into a first differential signal and a second differential signal in correspondence with the LVDS transmission method.

8. The display apparatus of claim 7, wherein the data signal comprises three pairs of the first and second data differential signals, and the clock signal comprises a pair of the first and second differential signals.

9. A display apparatus comprising:
a display panel having a plurality of pixel parts;
a connector receiving a driving signal including a first differential signal and a second differential signal;
a timing control section receiving the driving signal to control the pixel parts;
a plurality of signal lines transmitting a driving signal provided from the connector to the timing control section; and
a noise suppression part connected to the signal lines to suppress a noise component of the driving signal.

10. The display apparatus of claim 9, wherein the noise suppression part comprises a capacitor.

11. The display apparatus of claim 9, wherein the signal lines comprise:
a first differential line transmitting the first differential signal to the timing control section; and
a second differential line transmitting the second differential signal to the timing control section.

12. The display apparatus of claim 11, further comprising:
a differential resistor disposed between the first and second differential lines.

13. The display apparatus of claim 11, wherein the noise suppression part comprises:
a first differential capacitor having a first terminal connected to the first differential line and a second terminal connected to a ground potential; and
a second differential capacitor having a first terminal connected to the second differential line and a second terminal connected to the ground potential.
